(19) United States
(12) Patent Application Publication
(10) Pub. No.: US 2017/0178204 A1
(43) Pub. Date: Jun. 22, 2017

(54) Recommendation Generation

(71) Applicant: digi.me Limited, Tongham Surrey (GB)

(72) Inventor: Julian Francis Osborn Ranger, Surrey (GB)

(73) Assignee: digi.me Limited, Tongham Surrey (GB)

(21) Appl. No.: 15/117,105

(22) PCT Filed: Feb. 6, 2015
(86) PCT No.: PCT/GB2015/050333

§ 371 Date: Aug. 5, 2016

(30) Foreign Application Priority Data
Feb. 7, 2014 (GB) 1402088.7

(51) Int. Cl. G06Q 30/02; H04L 29/06; H04W 12/08; G06F 21/62; G06Q 30/06; G06F 17/30

(52) U.S. Cl. CPC G06Q 30/0282; G06Q 30/0283; G06Q 30/0631; G06F 17/30035; H04W 12/08; G06F 21/6218; H04L 63/102

(57) ABSTRACT

A method of recommending a supply by a recommender to a user having personal data available electronically consists in the steps of: • granting permission by a user for a facilitator's software to retrieve an excerpt of the user's personal data for use in generating a recommendation; • organising the user's data into a standard, interrogatabie format and storing the formatted data in a storage location; • pre-allocating by a facilitator' software to the recommender a recommender's code for use in conjunction with the recommender's recommendation generating software, the latter including a specification for certain fields of user's data, requesting by the user of a recommendation of goods or services via the recommender's software; • running of the recommender's software to pass the recommender's pre-allocated code to the user's data processor; • passing of the user's pre-allocated code and the recommender's pre-allocated code to the facilitator's interface software; • running of the facilitator's software to retrieve an excerpt of the user's data for the specified fields from the storage location for use by the recommender's software in generating the recommendation; • running of the recommender's software to generate the recommendation for the user utilising the excerpt of the user's data.

The present invention relates to generation of a recommendation.

Recommendations are made in many walks of life, many but not all broadly commercial. For instance, estate agents recommend houses, opticians recommend spectacles, doctors recommend medicines, car dealers recommend cars, insurance agents recommend policies, market comparison website recommend a variety of goods and services. Use of the present invention can be envisaged in these and many other fields. Accordingly it is described in broad terms of a recommendation from a supplier to a user of goods or services regardless of whether the supply will be a commercial supply, i.e. in exchange for money or money's worth, or a free supply, i.e. a gift.

A recommended supply to one user is likely to differ from that to another in accordance with the individual user's personal details, statistics, circumstances etc. Insofar as these are often available in electronic form, they are referred to here as a user's personal data. In connection with a house purchase they can include desired location, desired size of house, available deposit and available income to support a mortgage. In connection with spectacles, they can include optometrist's prescription, facial measurements and photographs.

Much personal data is available on a user's data processor or stored remotely from the user's data processor in a number of personal databases. Software is available for analysing these personal databases, such as Facebook® accounts, to extract such data and store it in standardised format in a memory on the user's data processor or preferably in a secure remote memory.

Currently, users seeking a recommendation, from a price comparison website for instance, have to enter much of the data manually. This is time consuming and is a constraint on the number of recommendation that a user can obtain in limited amount of time.

The object of the present invention is to improve recommendation generation.

The concept of the invention is that a facilitator has recorded pre-allocated codes of suppliers and users. When he receives from a user a pair of such codes pre-allocated to the user and a supplier, he retrieves the user's relevant personal data for use in the recommendation generation to the user by the supplier.

The concept can be given effect to in various aspects linked by the same concept, in analogous manner to the linking of transmitter and receiver aspects utilising a common concept.

According to a first aspect of the invention there is provided a method of recommending a supply by a recommender to a user having personal data available electronically, the method consisting in the steps of:
granting permission by a user for a facilitator's software to retrieve an excerpt of the user's personal data for use in generating a recommendation;
organising the user's data into a standard, interrogatable format and storing the formatted data in a storage location;
pre-allocating by a facilitator' software to the recommender a recommender's code for use in conjunction with the recommender's recommendation generating software, the latter including a specification for certain fields of user's data,
requesting by the user of a recommendation of goods or services via the recommender's software;
running of the recommender's software to pass the recommender's pre-allocated code to the user's data processor;
passing of the user's pre-allocated code and the recommender's pre-allocated code to the facilitator's interface software;
running of the facilitator's software to retrieve an excerpt of the user's data for the specified fields from the storage location for use by the recommender's software in generating the recommendation;
running of the recommender's software to generate the recommendation for the user utilising the excerpt of the user's data.

In certain embodiments:
the permission grant step includes registration by the user with the facilitator's software and pre-allocation by the facilitator's software to the user of a user's code and
the data organisation step includes storage of the formatted data at a location accessible to the facilitator's software.

As used herein, the term “data processor” is used broadly to encompass all computers, particularly but not limited to mobile telephones, laptop computers, desk top computers, racked computers and main frame computers, either owned by the person(s) operating them or running software, applications and/or programs for these persons either under contract or under any free access arrangement.

As used herein, a memory or storage location associated, linked, connected to etc. a data processor can be a memory, in particularly a hard drive, physically resident with the data processor. Alternatively, it can be a remote, off-site or “cloud” memory, a cloud memory being a memory accessible by the data processor via the internet or local network.

Whilst it is envisaged that the recommender's software could be run on the recommender's data processor, it is expected that normally the software will be downloaded to be run on the user's data processor, without any of the user's data passing to the recommender. Nevertheless, in certain circumstances, certain of the user's data may be passed to the recommender, for instance to allow an estate agent to forward relevant particulars to the user during the coming weeks.

Whilst the user's pre-allocated code will be unique to the user, and normally relatively long; it is conceivable that the recommender's code could be at least partially generic, that is to say including a portion indicating the type of recommender, possibly associated with the identity of the specified fields, and a shorter section identifying the actual recommender within the type.

Preferably, the method includes the step of display of the identity of the specified fields to the user. It can also include the step of approving to the facilitator the use of these fields as a precursor to the step of the retrieving the user's data stored in the fields in the memory. As an additional step in security of the method the specification of the fields can be displayed to the user only following their identification by the facilitator to the user. In this case the recommender's code will be pre-allocated only on identification of the specified fields to the facilitator.

The facilitator could be an individual operating a data processor, but will usually be a data processor, typically operating automatically.

According to a second aspect of the invention there is a user's method in obtaining a recommendation, the user having personal data organised in an interrogatable format and stored in a storage location, the method consisting in the following steps performed by the user or on behalf of the user via a user's data processor:
requesting of a recommender a recommendation of a supply, the request being made via the recommender's recommendation software, running of the recommender's software passing a recommender's pre-allocated code to the user's data processor; and
on receipt by the facilitator's software of the excerpt of the user's personal data for use with the recommender's software to generate the recommendation and passage of it to the recommender's software, receiving from the recommender's software a recommendation generated in accordance with the excerpt.

The user's method preferably includes the steps of the user:
receiving notification of the excerpt to be passed to the recommender's software and
approving passing of the excerpt.

Further the user's method preferably includes the following steps of approval:
reviewing a display of specified fields for which an excerpt of the user's data is to be made available to the recommender's software for the preparation of the recommendation and approving of the specified fields; and/or
reviewing and approving the excerpt of the user's data after retrieval by the facilitator's software and before it is made available to the recommender's software; and/or
reviewing and approving the or a selection of the excerpt of the user's data, preferably after the recommendation has been generated, for passing of it to the recommender for the generation of future recommendations without further action by the user.

The passing of the pre-allocated codes can be under the control of the user, via a prompt to allow this, or it can be automatically performed by a software routine installed on the user's data processor, with the performance instigated by the downloading of the recommender's software.

Normally the user will have organised the user's personal data in advance with the user of proprietary software.

According to a third aspect of the invention there is a recommender's method in generating a recommendation, the method consisting in the following steps performed by the recommender or on behalf of the recommender via a recommender's data processor and a user's data processor:
memorising a recommender's code, following application to a facilitator's software for such code for the purposes of performing a recommendation at a user's data processor, the recommender's code having embedded in it identity of personal-data, excerpt-fields for use in the recommendation or the identity of personal-data, excerpt-fields being memorised for the recommender's having the respective recommender's code;
downloading recommendation generation software to the user's data processor, the download including the recommender's code and
the software at the user's data processor receiving an excerpt of the user's personal data and generating the recommendation.

The recommender's code can identify personal data fields, whose data will form the excerpt, whereby the facilitator's data processor does not need to look up the fields appropriate to the recommender's code. Alternatively, the identity of the fields concerned can be memorised by or looked up by the facilitator's data processor.

The recommender's method can include receiving and storing the excerpt data for its future use in future recommendations.

According to a fourth aspect of the invention there is a facilitator's method in a user obtaining a recommendation, the user having personal data organised in an interrogatable format, the method consisting in the following steps performed by the facilitator or on behalf of the facilitator via a facilitator's data processor:
pre-allocating a recommender's code to a recommender, the code being associated with or having embedded in it the identity of personal data fields required for preparing a recommendation;
on granting of permission by a user for a facilitator's software to retrieve an excerpt of the user's personal data for use in generating a recommendation;
receiving a request from the user for a recommendation and a recommender's code from a prospective recommender and verifying the permission and the recommender's code are genuine;
identifying user's personal data fields to be used in preparing a recommendation associated with the recommender's code;
retrieving to the user's data processor or facilitating such retrieval by the user's data processor of the user's data for the said fields.

Preferably the facilitator's method includes:
pre-allocating a user's code to a user receipt of the user's permission;
receiving a code pair from a user, the code pair comprising a recommender's code and a user's code;
verifying that the codes are genuine.

Preferably, the data fields will be communicated to the user's data processor for viewing by the user and approval prior to retrieval or facilitation of retrieval.

Preferably the personal data fields associated with the recommender's code will be stored in a memory associated with the facilitator's data processor, although their identity could be embedded in the recommender's code.

The memory address of the user's organised personal data could be memorised in the facilitator's data processor's memory. Alternatively the address could be embedded in the user's pre-allocated code. Where information such as data fields for excerpt production and a memory address is embedded in a code, it can be encrypted prior to allocation of the code and the encryption key retained by the facilitator, whereby only the facilitator has be ability to access such information. Where such information is encrypted in codes, the facilitator has not need to memorise any information, except for the encryption code. All data required for the facilitator's method can be decryptable from the codes.

The facilitator can perform the preliminary step of organising the user's personal data into standard interrogatable format as a preliminary step.

To help understanding of the invention, a specific embodiment thereof will now be described by way of example and with reference to the accompanying drawings, in which:

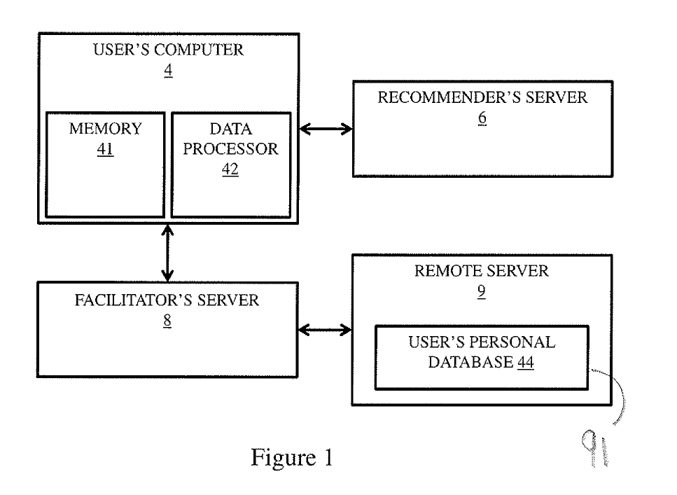

FIG. 1 is a block diagram of an arrangement for generation of a recommendation in accordance with a first embodiment of the invention;

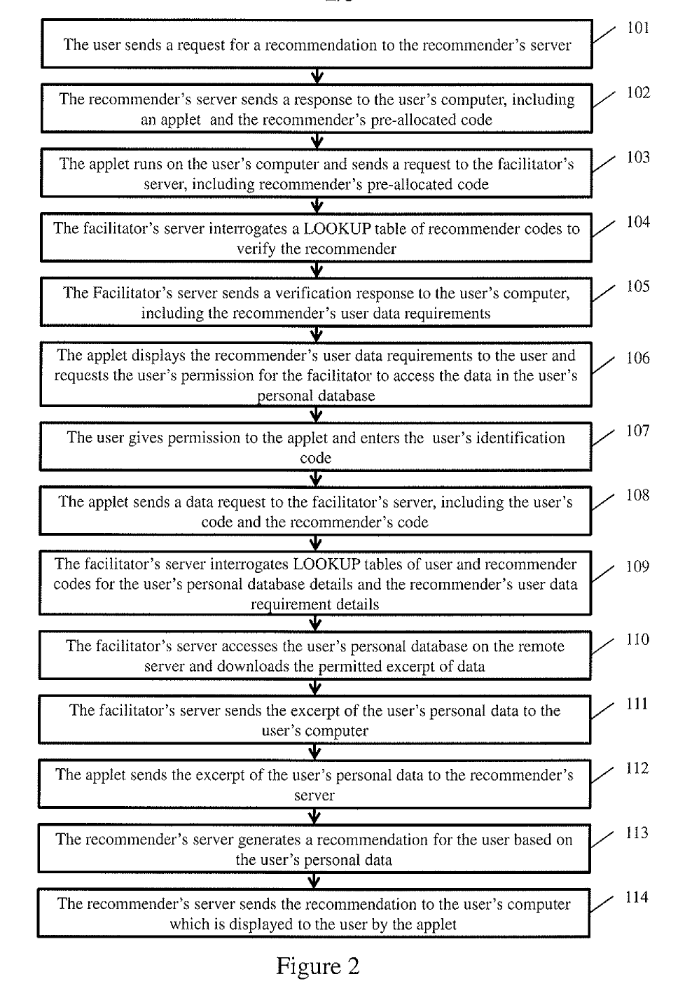

FIG. 2 is a flowchart diagram of the operation of the arrangement of FIG. 1 in generation of a recommendation;

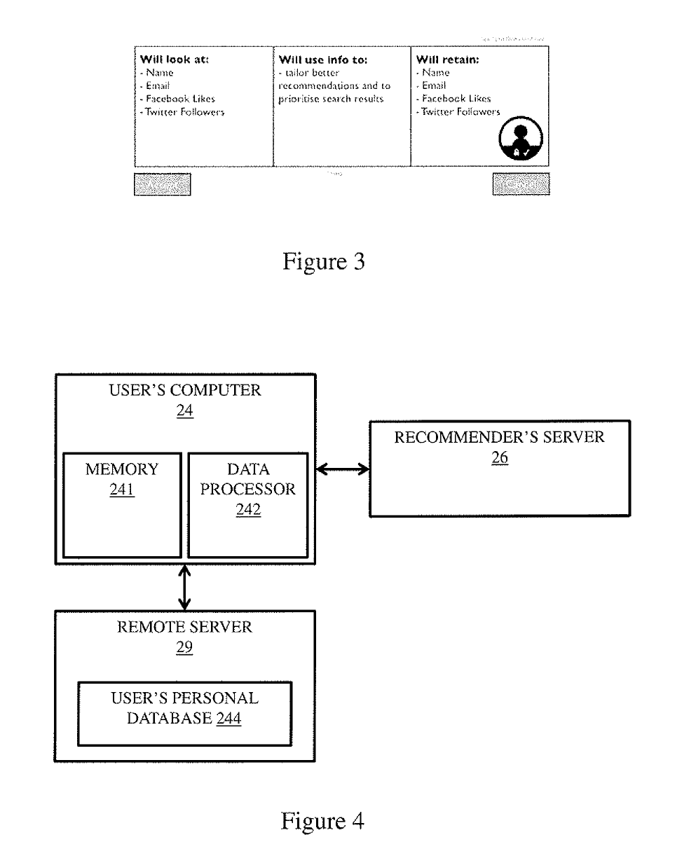

FIG. 3 is a table of recommender user data requirements in accordance with the method steps of FIG. 2;

FIG. 4 is a block diagram of an alternative arrangement for generation of a recommendation in accordance with a second embodiment of the invention;

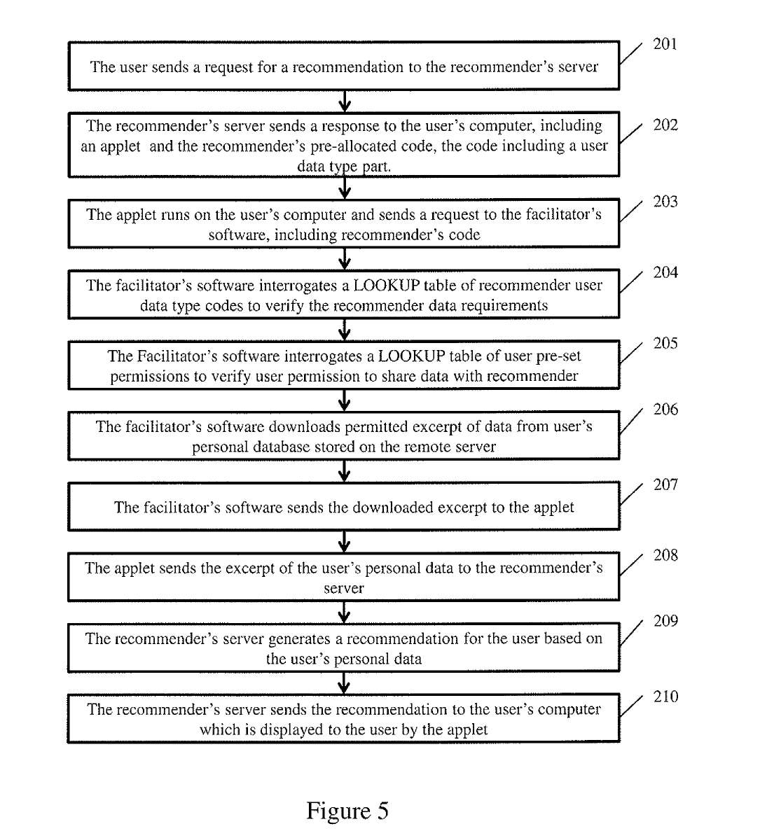

FIG. 5 is a flowchart diagram of the operation of the arrangement of FIG. 4 in generation of a recommendation; and

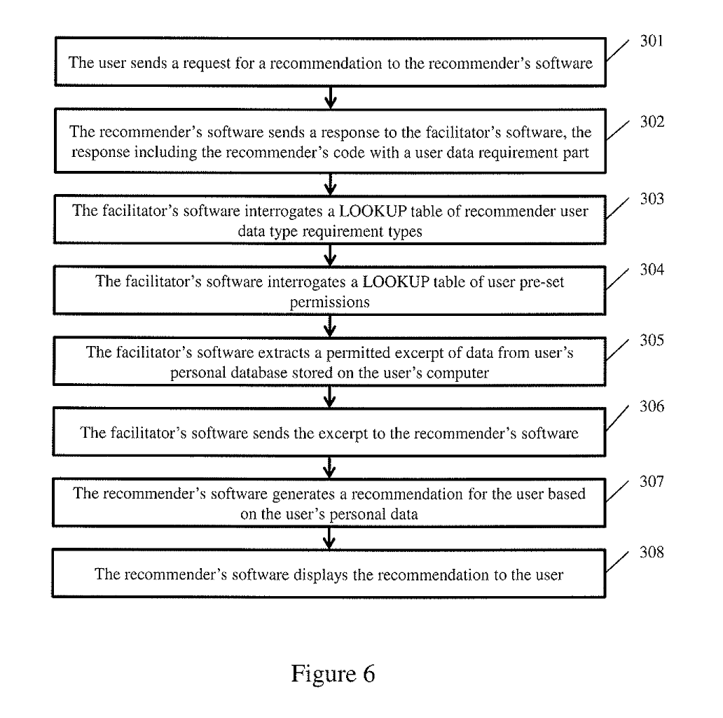

FIG. 6 is a flowchart diagram of the operation of an alternative arrangement for generation of a recommendation in accordance with a third embodiment of the invention.

Referring to FIG. 1, a first embodiment of the invention includes a user's personal computer 4, a recommender's server 6, a facilitator's server 8 and a remote server 9. The user's computer 4 and servers 6, 8, 9 each are connected to, and accessible via, the internet. The user's computer has a local memory 41 and a data processor 42 and an internet browser program is installed on the computer. The remote server 9 has a local memory 91. A user's personal database 44, containing records of personal details, statistics, circumstances etc. of the user, is stored on the memory 91 of the remote server.

Prior to the generation of a recommendation, both a user and a recommender are required to register with a facilitator.

The user is required by the facilitator to identify the location of the user's personal database and provide access details to the database, such as username and password. This is typically done by the user creating an account on the facilitator's website. On completion of registration, the user is provided by the facilitator with a unique user identification code. The user identification code and personal database location and access details are stored securely by the facilitator in a LOOKUP table on the facilitator's server.

The recommender is required to provide the facilitator with its user data requirements, including the specific field's from the user's database that the recommender requires access to for generation of a recommendation and what is to be done with the data once it has been received. This information from the recommender will be referred to as the recommender's user data requirement details. On completion of registration, the recommender is provided by the facilitator with a unique recommender identification code. The recommender identification code and user data requirement details are stored securely by the facilitator in a LOOKUP table on the facilitator's server.

Referring to FIG. 2, in operation a recommendation is generated by a recommender for a user by the following method steps:
101. the user visits the recommender's website on the personal computer 4 by typing in the recommender's URL into the internet browser, whereby the browser transmits a request to the recommender's server 6;
102. the recommender's server receives the user's request and transmits a response to the user's computer. The response includes the recommender's identification code and an applet (a small program) to be run on the user's computer within the browser;
103. the recommender's webpage is displayed on the user's browser and the applet is run within the browser. On running, the applet transmits a verification request to the facilitator's server 7, the request including the recommender's pre-allocated identification code;
104. the facilitator's server receives the applet request and interrogates the stored LOOKUP table of recommender's details for the recommender identification code;
105. on finding the recommender identification code, the facilitator's server transmits a response to the applet on the user's computer containing the recommender's user data requirement details;
106. the applet receives the facilitator's response and displays the recommender's user data requirement details, such as the specific fields required from the user's personal database, how the data will be used and how long it will be stored for, to the user in a table as shown in FIG. 3. This step verifies to the user that the recommender is registered with the facilitator and informs the user of the data that is to be provided to the recommender by the facilitator and how it is to be used by the recommender. The applet also provides an “accept” button for the user to select to give permission to the facilitator to retrieve the specific data from the user's personal database and to send it to the recommender for use in generation of a recommendation;
107. on the user selecting the accept button in the applet, the applet prompts the user to enter their unique user identification code;
108. on the user entering the user's identification code, the applet transmits a data request to the facilitator's server including both the receiver's identification code and the user's identification code;
109. the facilitator's server receives the applet's request and interrogates both the LOOKUP table of user's data, to find the user's identification code and to locate the user's personal database access details, and the LOOKUP table of recommender's details, to find the recommender's identification code and to determine the specific fields of the user's personal database that the user has granted permission for the facilitator to access;
110. the facilitator's server locates the user's personal database on remote server 9, via the stored database location and access details, and downloads the specific fields requested by the recommender to the facilitator's server;
111. the facilitator's server transmits the downloaded excerpt of the user's personal database to the applet on the user's computer;
112. the applet sends the excerpt of the user's personal database to the recommender's server;
113. the recommender's server determines a suitable recommendation for the user based on the excerpt of the user's personal database; and
114. the recommender's server transmits the recommendation to the applet on the user's computer, whereby the recommendation is displayed to the user.

The excerpt of the user's personal database may be stored on the recommender's server for a period of time, in accordance with the user's permission, so that further recommendations may be sent to the user via email or other notification methods.

The invention is not intended to be restricted to the details of the above described embodiment. For instance, the user may not be required to enter the user's identification code to the applet, rather the user's identification code may be stored in a cookie or other form on the user's computer and retrieved by the applet on the user selecting the accept button. Alternatively, the user's code may be sent to the recommender's server in a cookie or other form, however this method is not preferred by the applicant due to the possibility of misuse by the recommender.

The user's personal database may be stored on the memory of a server remote from the user's computer or a device such as a Network Assisted Storage (NAS) box.

It is envisaged that a facilitator's software may be installed on the user's computer, such as a plugin in the user's browser or a separate program. The user's code may be stored by the facilitator's software and the applet may cooperate with the facilitator's software to retrieve the user's code. In some cases, the facilitator's software, on instruction from the applet, may itself transmit the data request to the facilitator's server, the applet providing the facilitator's software with the recommender's code. Furthermore, in some cases, the facilitator's software on the user's computer may directly access the user's personal database, extract the requested and authorised excerpt of the user's data and transmit the excerpt to the recommender's applet, without the user's data being transmitted to the facilitator's server.

Optionally, where a facilitator's software is installed on the user's computer, the facilitator's software may monitor incoming responses from web servers to the user's computer, in a similar manner to many commonplace antivirus software which will be familiar to the skilled person. On identifying a recommender's code in an incoming response, the facilitator's software may transmit a message to the facilitator's server, including the recommender's code, whereby the facilitator's server checks that the recommender's code is genuine against the LOOKUP table of recommender's details. On verifying that the code is genuine, facilitator's server can send a confirmation response to the facilitator's software on the user's computer, which is then displayed to the user to confirm that the recommender is genuine and is authorised by the facilitator. The confirmation response may also include details of the recommender's data requirements. Alternatively, the facilitator's software may be adapted to determine the authenticity of the recommender's code without sending a message to the facilitator's server.

Optionally, the excerpt of the user's data may be displayed to the user before transmittal to the recommender's applet or server, to provide a further verification step for the user. Alternatively, after the excerpt of the user's personal data is downloaded onto the facilitator's server, the excerpt may be sent from the facilitator's server directly to the recommender's server.

It is also envisaged that, in some instances, the applet running in the browser of the user's computer may be capable of using the excerpt of the user's personal data to generate a recommendation for the user without the data being sent to the recommender's server.

Referring to FIG. 4, an alternative embodiment of the present invention includes a user's personal computer 24, a recommender's server 26 and a remote server 29. The user's computer 24 and servers 26, 29 each are connected to, and accessible via, the internet. The user's computer has a local memory 241 and a data processor 242 and has installed on it a facilitator's software and an internet browser software. The user has a user's personal database 244, containing records of personal details, statistics, circumstances etc. of the user, stored on the memory of the remote server 29.

Again, both the user and the recommender are required to register with the facilitator before generation of a recommendation. The user and recommender codes are generated by the facilitator as in the previous embodiment, however in this embodiment a facilitator's server is not required to store LOOKUP tables of user or recommender details.

In this embodiment, the user's unique code is stored in the user's personal computer by the facilitator's software. On opening of the facilitator's software on the user's computer, the user is prompted to “login” by entering the code, or alternatively a username and password associated with the code.

In this embodiment, the recommender's code is comprised of several parts, including a unique recommender identification part and a user data requirement part. The user data requirement part is not unique to the recommender, but rather is unique to user data requirement types. An example of a user data requirement type, such as for an insurance recommender, is the requirement by the insurance recommender to store a user's email address and current insurance premium details for twelve months in order to send an expiry and renewal reminder to the user the following year. A LOOKUP table of user data requirement types and codes is stored on the user's computer by the facilitator's software.

The facilitator's software on the user's computer also stores a LOOKUP table of user pre-set permissions. The user pre-set permissions are permissions granted in advance by the user to the facilitator's software, for the facilitator's software to access and transmit certain excerpts of the user's personal database in accordance with specific recommender user data requirements. For example, a user may give permission for the facilitator software to, but not to that will be stored for more than twelve months.

Referring to FIG. 5, in operation a recommendation is generated by a recommender for a user by the following method steps:
201. the user visits the recommender's website on the personal computer 24 by typing in the recommender's URL into the internet browser, whereby the browser transmits a request to the recommender's server 26;
202. the recommender's server receives the user's request and transmits a response to the user's computer. The response includes the recommender's code and an applet to be run on the user's computer within the browser;
203. the recommender's webpage is displayed on the user's browser and the applet is run within the browser. On running, the applet sends a request, including the recommender's code to the facilitator's software on the user's computer;
204. the facilitator's software receives the applet request and uses the user data requirement type part of the recommender's code to interrogate a LOOKUP table of recommender's user data requirement types stored by the software on the user's computer.
205. on finding the recommender's data request type, the facilitator's software interrogates the user defined security settings for pre-allocated user permission to share the requested personal data with the recommender;
206. on verification of pre-allocated user permission, the facilitator's software locates the user's personal database on the remote server 29, accesses the database using the user's access details and downloads the specific requested fields to the user's device;
207. the facilitator's software transmits the downloaded excerpt of the user's personal database to the applet;
208. the applet sends the excerpt of the user's personal database to the recommender's server;
209. the recommender's server uses the excerpt of the user's personal data to determine a recommendation for the user; and
210. the recommender's server transmits the recommendation to the applet on the user's computer, whereby the recommendation is displayed to the user.

In this embodiment, a facilitator's server is not given access to the user's personal database and the user's personal data is not transferred to the facilitator's server. In fact, the only part of the user's personal data that is transferred to a third party server, other than the remote server on which the personal database is stored, is the excerpt retrieved by the facilitator's software on the user's computer once it has been transmitted to the applet. The downloaded excerpt also need not be transferred to the recommender's server, provided that the applet is adapted to generate a recommendation without sending the excerpt to the recommender's server.

Another alternative embodiment of the present invention includes a user's personal computer 24, having a local memory 341 and a data processor 342 and having installed on it a facilitator's software and a recommender's software. The user has a user's personal database 344, containing records of personal details, statistics, circumstances etc. of the user, stored on the memory 341 of the user's computer.

In use, a recommendation is generated by a recommender for a user by the following steps:
301. the user opens the recommender's software on the personal computer 34 and requests the software to generate a recommendation;
302. the recommender's software receives the user's request and transmits a response, including the recommender's code, to the facilitator's software on the user's computer;
303. the facilitator's software receives the recommender's software request and uses the “data request type” part of the recommender's code to interrogate a LOOKUP table of recommender's data requests stored by the software on the user's computer;
304. on finding the recommender's data request type, the facilitator's software interrogates the user defined security settings for pre-allocated user permission to share the requested personal data with the recommender;
305. on verification of pre-allocated user permission, the facilitator's software accesses the user's personal database and extracts the specific requested fields;
306. the facilitator's software transmits the extracted excerpt of the user's personal database to the recommender's software;
307. the recommender's software receives the extracted excerpt from the facilitator's software and determines a recommendation for the user based on the user's data; and
308. the recommender's software displays the recommendation to the user.

In this embodiment, no connection of the user's computer to the internet is required for the generation of a recommendation. Typically the facilitator's software and the recommender's software will be downloaded from respective facilitator and recommender servers via the internet, or CDROM or alternatively they may be preinstalled on the device at the factory. With no connection to the internet, the facilitator's software requires and the recommender's software requires.

It is envisaged that the unique user codes may be pre-allocated by the facilitator and given to the user in the form of a license key. On installation of the facilitator's software on the user's data processor, a valid license key must be entered for the software to run.

1. A method of recommending a supply by a recommender to a user having personal data available electronically, the method consisting in the steps of:
granting permission by a user for a facilitator's software to retrieve an excerpt of the user's personal data for use in generating a recommendation;
organising the user's data into a standard, interrogatable format and storing the formatted data in a storage location;
pre-allocating by a facilitator' software to the recommender a recommender's code for use in conjunction with the recommender's recommendation generating software, the latter including a specification for certain fields of user's data,
requesting by the user of a recommendation of goods or services via the recommender's software;
running of the recommender's software to pass the recommender's pre-allocated code to the user's data processor;
passing of the user's pre-allocated code and the recommender's pre-allocated code to the facilitator's interface software;
running of the facilitator's software to retrieve an excerpt of the user's data for the specified fields from the storage location for use by the recommender's software in generating the recommendation;
running of the recommender's software to generate the recommendation for the user utilising the excerpt of the user's data.

2. A recommendation method according to claim 1, wherein:
the permission grant step includes registration by the user with the facilitator's software and pre-allocation by the facilitator's software to the user of a user's code and
the data organisation step includes storage of the formatted data at a location accessible to the facilitator's software.

3. A recommendation method according to claim 1, wherein the recommender's software is run on the recommender's data processor.

4. A recommendation method according to claim 1, wherein the recommender's software is downloaded and run on the user's data processor, without any of the user's data passing to the recommender.

5. A recommendation method according to claim 1, wherein the recommender's software is downloaded and run on the user's data processor, with certain of the user's data being passed to the recommender.

6. A recommendation method according to claim 1, wherein
the user's pre-allocated code is unique to the user, and
the recommender's code is at least partially generic.

7. A recommendation method according to claim 6, wherein the recommender's code includes a portion indicating the type of recommender and a shorter section identifying the actual recommender within the type.

8. A recommendation method according to claim 1, including the step of display of the identity of the specified fields to the user.

9. A recommendation method according to claim 1, including the step of approving to the facilitator the use of these fields as a precursor to the step of the retrieving the user's data stored in the fields in the memory.

10. A recommendation method according to claim 9, including an additional, security step of display to the user of the specification of the fields only following their identification by the facilitator to the user and pre-allocation of the recommender's code only on identification of the specified fields to the facilitator.

11. A recommendation method according to claim 1, wherein the facilitator is an individual operating a data processor or a data processor, typically operating automatically.

12. A user's method in obtaining a recommendation, the user having personal data organised in an interrogatable format and stored in a storage location, the method consisting in the following steps performed by the user or on behalf of the user via a user's data processor:
requesting of a recommender a recommendation of a supply, the request being made via the recommender's recommendation software, running of the recommender's software passing a recommender's pre-allocated code to the user's data processor; and
on receipt by the facilitator's software of the excerpt of the user's personal data for use with the recommender's software to generate the recommendation and passage of it to the recommender's software, receiving from the recommender's software a recommendation generated in accordance with the excerpt.

13. A user's method according to claim 12, including the steps of the user:
receiving notification of the excerpt to be passed to the recommender's software and
approving passing of the excerpt.

14. A user's method according to claim 12, including the following steps of approval:
reviewing a display of specified fields for which an excerpt of the user's data is to be made available to the recommender's software for the preparation of the recommendation and approving of the specified fields; and/or
reviewing and approving the excerpt of the user's data after retrieval by the facilitator's software and before it is made available to the recommender's software; and/or
reviewing and approving the or a selection of the excerpt of the user's data, preferably after the recommendation has been generated, for passing of it to the recommender for the generation of future recommendations without further action by the user.

15. A user's method according to claim 12, including passing of a user's code to a facilitator's software for verification that the recommender is authorised to receive an excerpt of the user's personal data for the purpose of generating the recommender's recommendation;

16. A user's method according to claim 15, wherein the passing of the user's code is under the control of the user, via a prompt to allow this, or is automatically performed by a software routine installed on the user's data processor, with the performance instigated by the downloading of the recommender's software.

17. A user's method according to claim 12, including the preliminary step of the user having organised the user's personal data in advance with the use of the facilitator's software.

18. A recommender's method in generating a recommendation, the method consisting in the following steps performed by the recommender or on behalf of the recommender via a recommender's data processor and a user's data processor:
memorising a recommender's code, following application to a facilitator's software for such code for the purposes of performing a recommendation at a user's data processor, the recommender's code having embedded in it identity of personal-data, excerpt-fields for use in the recommendation or the identity of personal-data, excerpt-fields being memorised for the recommender's having the respective recommender's code;
downloading recommendation generation software to the user's data processor, the download including the recommender's code and
the software at the user's data processor receiving an excerpt of the user's personal data and generating the recommendation.

19. A recommender's method according to claim 18, wherein the recommender's code identifies personal data fields, whose data will form the excerpt, whereby the facilitator's data processor does not need to look up the fields appropriate to the recommender's code.

20. A recommender's method according to claim 18, wherein the recommender's code identifies personal data fields, whose data will form the excerpt, and the identity of the fields concerned is memorised by or looked up by the facilitator's data processor.

21. A recommender's method according to claim 18, including receiving and storing the excerpt data for its future use in future recommendations.

22. A facilitator's method in a user obtaining a recommendation, the user having personal data organised in an interrogatable format, the method consisting in the following steps performed by the facilitator or on behalf of the facilitator via a facilitator's data processor:
pre-allocating a recommender's code to a recommender, the code being associated with or having embedded in it the identity of personal data fields required for preparing a recommendation;
on granting of permission by a user for a facilitator's software to retrieve an excerpt of the user's personal data for use in generating a recommendation;
receiving a request from the user for a recommendation and a recommender's code from a prospective recommender and verifying the permission and the recommender's code are genuine;
identifying user's personal data fields to be used in preparing a recommendation associated with the recommender's code;
retrieving to the user's data processor or facilitating such retrieval by the user's data processor of the user's data for the said fields.

23. A facilitator's method according to claim 22, including
pre-allocating a user's code to a user receipt of the user's permission;
receiving a code pair from a user, the code pair comprising a recommender's code and a user's code;
verifying that the codes are genuine.

24. A facilitator's method according to claim 22, wherein the data fields are communicated by the facilitator to the user's data processor for viewing by the user and approval prior to retrieval or facilitation of retrieval.

25. A method according to claim 1, claim 12, claim 18 or claim 22, wherein personal data fields associated with a recommender's code are stored in a memory associated with a facilitator's data processor.

26. A method according to claim 1, claim 12, claim 18 or claim 22, wherein:
personal data fields associated with a recommender's code are stored in a memory associated with a facilitator's data processor and
the identity of personal data fields associated with a recommender's code are embedded in a recommender's code.

27. A method according to claim 1, claim 12, claim 18 or claim 22, wherein the memory address of the user's organised personal data is in the facilitator's data processor's memory.

28. A method according to claim 1, claim 12, claim 18 or claim 22, wherein the memory address of the user's organised personal data is embedded in the user's pre-allocated code.

29. A method according to claim 1, claim 12, claim 18 or claim 22, wherein data field and/or memory address information embedded in a code, is encrypted prior to allocation of the code including the information, and the encryption key is retained by the facilitator, whereby only the facilitator has be ability to access such information.

30. A method according to claim 1, claim 12, claim 18 or claim 22, wherein:
data field and/or memory address information embedded in a code, is encrypted prior to allocation of the code including the information, and the encryption key is retained by the facilitator, whereby only the facilitator has be ability to access such information and
the facilitator memorises the encryption key and not the data field and address information as such.

31. (canceled)

32. (canceled)

33. (canceled)
